(19) United States
(12) Patent Application Publication
(10) Pub. No.: US 2009/0164923 A1
(43) Pub. Date: Jun. 25, 2009

(54) METHOD, APPARATUS AND COMPUTER PROGRAM PRODUCT FOR PROVIDING AN ADAPTIVE ICON

(75) Inventor: MORTEN OVI, Copenhagen (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/962,294

(22) Filed: Dec. 21, 2007

(51) Int. Cl. G06F 3/048

(52) U.S. Cl. 715/764

(57) ABSTRACT

An apparatus for providing an adaptive icon may include a processor. The processor may be configured to present an icon associated with a particular function, generate a dynamic element for inclusion in at least a portion of the icon, the dynamic element being indicative of a feature defined as a characteristic that is based on an internal parameter, and update the dynamic element based on changes associated with the feature.

### TECHNOLOGICAL FIELD

Embodiments of the present invention relate generally to user interface technology and, more particularly, relate to a method, apparatus and computer program product for providing an adaptive icon.

### BACKGROUND

As electronic device capabilities expand, increasingly large amounts of content, applications, peripheral devices, etc., may be accessed in connection with or utilized by electronic devices. However, the increase in device capability may be less appealing or useful to users of such devices if the capabilities cannot be employed in an efficient manner. As a result, efforts have been made to improve user interface (UI) technology to provide easier access to unlocking the capabilities of electronic devices.

Some electronic devices, like mobile terminals, may experience limitations with regard to their UI capabilities due to limitations in display size, text input speed, and other factors. Accordingly, mechanisms have been developed to assist mobile terminal users in accessing content or applications. For example, an idle screen is a common feature that forms the starting point and finishing point for many tasks associated with the mobile terminal. In this regard, whether making a call, checking a voicemail, sending a text, downloading a ringtone, or the like, the idle screen is typically encountered preceding and upon concluding such functions. A common UI mechanism is to provide soft or hard key access from the idle screen to menus or applications that may be utilized to perform various functions or access content or applications. In some instances, icons may be utilized to represent content, an application, a device, or the like that may be accessed via selection of the corresponding icon. However, in order to receive further information about content and/or an application behind an icon, one typically needs to activate the icon.

Recently, some icons have been developed that may change in appearance based on outside parameters. For example, an icon for a calendar application may indicate today's date on the icon. Additionally, an icon may change in appearance, for example, if the application corresponding therewith is already opened. However, these appearance changes are related to events or state information that is not necessarily only typically available via execution of the corresponding icon, but may be received from outside sources.

Accordingly, it may be desirable to provide an improved mechanism by which further information about content and/or an application behind an icon may be made available.

### BRIEF SUMMARY

A method, apparatus and computer program product are therefore provided with respect to an adaptive icon. In particular, a method, apparatus and computer program product are provided that may provide an icon that includes a dynamic element that is descriptive of the content and/or application behind the icon. Embodiments of the present invention may therefore provide improved or easier access to information regarding content and/or applications without requiring the user to select the corresponding icon to execute a function associated with the icon. Accordingly, embodiments may be useful, for example, when used in an active idle screen application. Thus, zero click access to information specific to content or an application associated with an icon may be enabled. As a result, for example, mobile terminal users may enjoy an improved content management capability and a corresponding improved ability to access information about content and/or applications represented by icons.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a block diagram of portions of an apparatus for providing an adaptive icon according to an exemplary embodiment of the present invention;

FIG. 3 illustrates an example of a graphical user interface employing an adaptive icon according to an exemplary embodiment of the present invention; and

FIG. 4 is a flowchart according to an exemplary method for enabling an improved content management capability according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

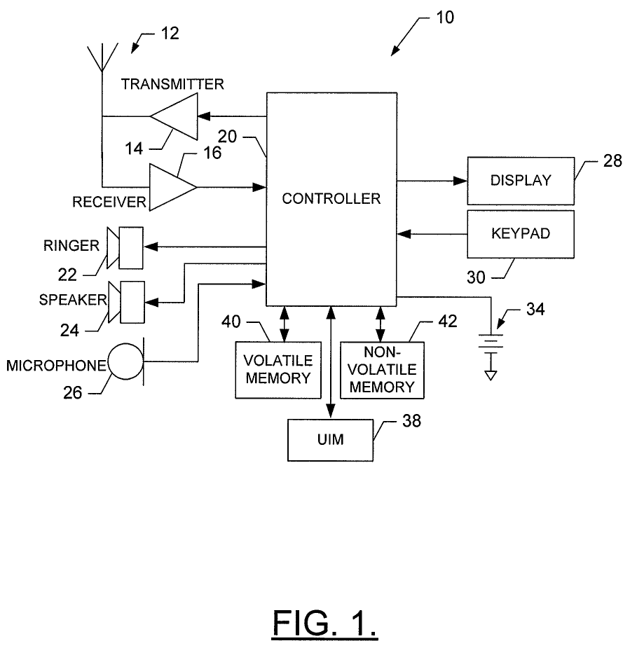

FIG. 1, one aspect of the invention, illustrates a block diagram of a mobile terminal 10 that may benefit from embodiments of the present invention. It should be understood, however, that a mobile telephone as illustrated and hereinafter described is merely illustrative of one type of electronic device that may benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, tablets, internet capable devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It should be understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick, scrolling device or other user input interface. The mobile terminal 10 may further include a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 may additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

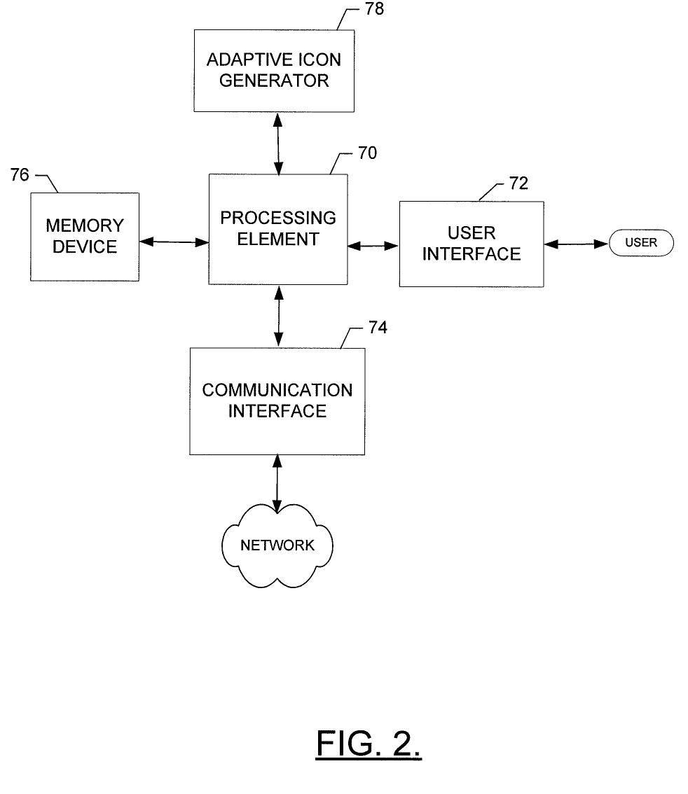

An exemplary embodiment of the invention will now be described with reference to FIG. 2, in which certain elements of an apparatus for providing an adaptive icon are displayed. The apparatus of FIG. 2 may be employed, for example, on the mobile terminal 10 of FIG. 1. However, it should be noted that the apparatus of FIG. 2, may also be employed on a variety of other devices, both mobile and fixed, and therefore, the present invention should not be limited to application on devices such as the mobile terminal 10 of FIG. 1. As an example of devices other than the mobile terminal of FIG. 1, the apparatus of FIG. 2 may be employed on a personal computer, a camera, a video recorder, a handheld computer, any of the devices mentioned above, and/or the like. Alternatively, embodiments may be employed on a combination of devices including, for example, those listed above. For example, a user interface of a client device according to embodiments of the present invention may enable the client device to access content stored at a serving device. It should also be noted that while FIG. 2 illustrates one example of a configuration of an apparatus for providing an adaptive icon, for example, in a mobile environment, numerous other configurations may also be used to implement embodiments of the present invention. As such, it should be noted that the devices or elements described below may not be mandatory and thus some may be omitted in certain embodiments.

Referring now to FIG. 2, an apparatus for providing an adaptive icon is provided. The apparatus may include a combination of entities or devices that may be embodied in hardware, software or a combination of hardware and software for use in connection with embodiments of the present invention. Although an embodiment will be described below in the context of certain content or applications, other types of content or applications may also be utilized in connection with adaptive icons generated in accordance with embodiments of the present invention.

In one example, embodiments of the present invention may be practiced by the apparatus embodied as a device such as the mobile terminal 10. In this regard, the apparatus may include or otherwise be in communication with a processing element 70 (e.g., controller 20), a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, content, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be a database that stores applications, information and/or media content. In an exemplary embodiment, different types of content items may be stored in separate folders or separate portions of the memory device 76. However, content items of different types could also be commingled within the memory device 76 or within folders of the memory device 76. For example, one folder within the memory device 76 could include content items related to types of content such as music, broadcast content (e.g., from the Internet and/or radio stations), video/audio content, pictures, etc. Alternatively, separate folders may be dedicated to each type of content. For example, a music library may be designated to receive content items associated with recorded song tracks.

The processing element 70 may be embodied in a number of different ways. For example, the processing element 70 may be embodied as a processor, a coprocessor, a controller or various other processing means or devices including integrated circuits such as, for example, an ASIC (application specific integrated circuit) or an FPGA (field programmable gate array). In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network and/or a wired connection interface (e.g., modem, universal serial bus (USB) connection, etc.) and supporting hardware and/or software for enabling wired communications with a network.

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a scrolling device, a touch screen display, a conventional display, a microphone, a speaker, or other input/output mechanisms. In an exemplary embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processing element 70 may be embodied as or otherwise control an adaptive icon generator 78. The adaptive icon generator 78 may be any means such as a device or circuitry embodied in hardware, software or a combination of hardware and software that is configured to perform the corresponding functions of the adaptive icon generator 78 as described in greater detail below. In this regard, for example, the adaptive icon generator 78 may be configured to generate an icon having a dynamic element for display via the user interface 72. The dynamic element may indicate information associated with the content or application behind the corresponding icon. In this regard, the information indicated may be information that is typically only available after selection of the icon. For example, the dynamic element may be embodied as a graphical element (e.g., an image, graphic, animated objected, etc.), a textual element (e.g., a word or series of letters, numbers, or characters), an additional (e.g., miniature) icon, or the like. The dynamic element could also be embodied as any combination of the above described examples. In some embodiments, the dynamic element may be a portion of the icon itself (e.g., hands on a watch, colors or sizes of particular portions of the icon, etc.). As a specific example, if the adaptive icon is associated with a mapping application or a GPS device, the adaptive icon may be presented with a shortcut icon that looks like a map. Accordingly, the dynamic element in such a situation may appear as the current location of the user indicated on the map. For example, a blinking dot, star or other indication (e.g., the dynamic element) may be provided of not only a map corresponding to the location proximate to the user, but also of the current location of the user.

An icon including a dynamic element as referred to herein may be defined as an adaptive icon or a descriptive icon. In this regard, the adaptive icon, and particularly at least one dynamic element associated with the adaptive icon, may be modifiable during the presentation of the adaptive icon. Modifications to the adaptive icon may be made, for example, based on changes to content associated with the adaptive icon. Accordingly, the dynamic element (and therefore the adaptive icon itself) may be indicative of a feature or characteristic of the content behind the adaptive icon. In other words, the dynamic element may be indicative of a feature or characteristic of the content or application that can be accessed or executed if the adaptive icon is selected. Accordingly, in an exemplary embodiment, a user may utilize the user interface 72 to view the adaptive icon in order to determine information associated with the content or application behind the adaptive icon since the dynamic element of the adaptive icon is rendered via the user interface 72.

Although, as indicated above, icons may be used to represent files, folders, applications, devices, etc., an icon may be considered to be representative of a particular function associated with the corresponding represented file, folder, application, device, etc., that may be performed in response to selection of the icon. For example, an icon associated with a word processing application may represent that selection of the icon opens the word processing application. Thereafter, for example, particular documents may be accessed or new documents may be created. Similarly, an icon associated with an album or file/folder including a plurality of pictures may represent that selection of the icon provides a series of thumbnail images corresponding to the pictures or provides a listing of corresponding image files for user selection. Accordingly, for example, particular pictures may be selected for rendering or inclusion in a message or web page. As yet another example, an icon associated with an email or text messaging application may represent that selection of the icon opens the email or text messaging application. Thereafter, for example, email and text messages may composed or viewed and may be sent or received. In other words, the icon may be associated with a particular function with respect to execution of an application, access to content, etc.

Adaptive icons may be similarly associated with a particular function with respect to execution of an application, access to content, etc. However, adaptive icons further include the dynamic element, which may form at least a portion of the adaptive icon. The dynamic element may further be indicative of a feature associated with execution of the particular function. The feature may be defined as a characteristic that is based on an internal parameter. In other words, for example, the dynamic element may be indicative of an internal parameter associated with the application associated with the adaptive icon and/or with the content associated with the adaptive icon. Moreover, the internal parameter may be a parameter (or parameters) that are accessible via execution of the function such as, for example, a parameter that are normally determinable after selection of the icon. Thus, unlike the conventional icon described above which includes an indication of date information, which comprises an external parameter that may be obtained independent of the execution of the application associated with the icon, adaptive icons may indicate information associated with internal parameters representative of state information associated with execution of the application or access to the content represented by the adaptive icons. In other words, adaptive icons may give the user a preview into an aspect or feature related to content that is normally only accessible by selection of the adaptive icon. As such, the user may receive advance information on some aspect or feature associated with the adaptive icon before the icon is even selected.

However, the adaptive icon may be more than a simple brief look up of an item related to a particular application. In this regard, the adaptive icon may be both dynamically updatable and provide a direct mechanism for interaction between the user and the application (e.g., the dynamic element). For example, although selection of the adaptive icon may launch the corresponding application or open the corresponding file or folder, selection of the dynamic element may provide access to a different function, subfolder, or the like. Thus, although the selection of the adaptive icon itself, like a conventional icon, may lead to a general and typical functional response, selection of the dynamic element within the adaptive icon may provide a more specific and different functional response. For purposes of illustration, consider the example embodiment in which an icon associated with an email or text messaging application is presented, such as upon an idle screen. The icon may be an adaptive icon having a dynamic element which indicates the number of new unread messages. Thus, if there are no new unread messages, actuation of the icon may simply direct the user to the message inbox, while if there are multiple new unread messages, actuation of the adaptive icon may direct the user to a list of the new unread messages to facilitate the user's review of the messages. In one embodiment, however, the dynamic element of the adaptive icon may indicate that there is only one new unread message. In this instance, actuation of the adaptive icon may automatically open the new message and may present the new message to the user to facilitate more prompt and efficient review of the new message with a minimum number of steps. As the foregoing example illustrates, the incorporation of additional information and intelligence into the adaptive icon and the associated dynamic element permits the actuation of the adaptive icon to provide access to a different function, subfolder or the like depending upon the state of the adaptive icon.

For example, with regard to the word processing application example above. A dynamic element may be used to indicate the number of documents currently opened or merely that a particular document is currently opened. With respect to the album or file/folder of pictures, a dynamic element may be indicative of the number of pictures in the album, the number of opened items in the album, the number of sub-folders in the album, that a particular picture is currently opened, etc. In connection with an exemplary email application as described above, the dynamic element may indicate that new mail has arrived, the number of new messages in the inbox, the number of stored drafts, etc. Furthermore, an indication of a change in the status of the application may also be indicated. In this regard, for example, if a change occurs in relation to a value upon which a dynamic element is based, the dynamic element may be updated in response to the change. In some embodiments, a separate indication may also be provided to alert the user that the dynamic element has changed. The separate indication may be visual, audible, mechanical or the like. Thus, for example, an adaptive icon may be enlarged, highlighted, experience a color change, or another change that may indicate (e.g., to a viewer of an active idle screen) that a change has occurred with respect to the dynamic element of the corresponding adaptive icon. Additionally, many other applications or types of content may also be represented by adaptive icons including corresponding dynamic elements that may be indicative of information associated with the content otherwise normally accessible only with the selection of the icon and therefore indicative of a feature corresponding with execution of the function (e.g., opening of the application, file, folder, etc.) associated with the icon.

In one example representative of the adaptive icon including, by virtue of the dynamic element, information beyond simple underlying data (e.g., advanced underlying data) may be provided. Accordingly, the internal parameters may be further defined as corresponding to advanced underlying data in some embodiments. In this regard, for example, if the adaptive icon represents a map application and the dynamic element corresponds to the user's current location, the information for providing the user's current location may be obtained from GPS data (or similar data from another source). Thus, the GPS data that is used to drive the current location indication may be provided from another application, thereby making the GPS data advanced underlying data. As another example, for an adaptive icon associated with a SMS or email application, the dynamic element may provide a small image comprising a picture, avatar or animation associated with the contact book from which the most recently received message was sent. Furthermore, for example, the user may define reactions for messages received from particular individuals or having particular subject lines so that an avatar of a smiling or frowning face may be embodied as a dynamic element providing an indication of advanced underlying data corresponding to an internal parameter (e.g., the content (e.g., presence of a keyword) or sender) associated with a particular message. As yet another example, the dynamic element could indicate a measure of the use or hit rate associated with the corresponding adaptive icon.

Continuing with the example provided above in which the dynamic element associated with an adaptive icon indicates the receipt of one new unread message, the selection of the adaptive icon in this instance may not only automatically open the one new unread message as described, but the underlying processor may determine the location of the sender of the new unread message and also provide a map or other indicia of the location of the sender. In this instance, an indication of the location of the sender may be provided as a form of advanced underlying data. As such, the processor can provide a map (either in all situations or only in instances in which the sender is within a predefined distance of the user) from the perspective of the user (based upon the current location of the user's electronic device) to the sender of the new, unread message. As noted above, the association of advanced underlying data with the adaptive icon and the associated dynamic element therefore permits the selection of the adaptive icon to provide access to even more functions, subfolders or the like.

Another characteristic of an adaptive icon is that the adaptive icon may be changeable responsive to changes of the dynamic element. As such, the adaptive icon may change or update with changes associated with the feature. In this regard, the adaptive icon generator 78 may not only be configured to generate the adaptive icon and the corresponding dynamic element, but the adaptive icon generator 78 may be further configured for updating the dynamic element based on changes associated with the feature. Furthermore, in an exemplary embodiment, the adaptive icon generator 78 may be configured to provide the adaptive icon, including providing updates to the adaptive icon, while displaying the adaptive icon in an active idle mode. However, it should be understood that the adaptive icon is not limited to use in connection with the active idle mode. The active idle mode may be somewhat similar to the idle mode except that the active idle mode may include interactive elements therein. Embodiments of an active idle screen provided in the active idle mode may enable zero click access to and discovery of features, services, advertising and the like. The active idle mode may be provided, for example, by an application replacing the idle screen that would be presented in a conventional idle mode. The active idle mode, which is typically considered in reference to application with mobile terminals, resembles PC desktop or dashboard applications that may provide similar functionality.

The adaptive icon generator 78 may update dynamic icons on a routine or periodic basis. For example, a predetermined interval may be established at which time the adaptive icon generator 78 may update all adaptive icons by accessing information corresponding to the feature upon which the respective adaptive icons are based. Alternatively, different intervals may be set for different applications. As yet another alternative, updates to adaptive icons may be accomplished in response to predetermined events. For example, changes to the feature may trigger an update to the dynamic element corresponding therewith. Other events, such as start up, refresh operations, execution of particular functions, highlighting of an adaptive icon, entry into active idle mode, display of an active idle icon bar, etc., may trigger updating of dynamic elements and their corresponding adaptive icons. Furthermore, in some embodiments, the dynamic elements may be enlarged or otherwise highlighted when a corresponding adaptive icon is selected or highlighted.

In an exemplary embodiment, the adaptive icon generator 78 may be configured to enable a user of a device employing embodiments of the present invention to modify display properties associated with the adaptive icons. For example, the user may be able to modify display properties associated with the dynamic element. In this regard, for example, the user may be enabled to turn dynamic elements on or off. In some exemplary cases, a user profile may indicate whether adaptive icons are enabled or disabled. Furthermore, in some embodiments, the user may be able to fully or partially customize the adaptive icons. For example, the user may customize graphics associated with a particular dynamic element, customize circumstances under which the dynamic element is displayed, customize the feature with which the dynamic element is associated, and the like. However, display properties associated with adaptive icons may also be fixed or modifiable only within limits predetermined by the manufacturer.

In some embodiments, dynamic elements may include characteristics that may be augmented or characteristics that may change based on conditional relationships associated with the feature. In this regard, for example, the user may be able to define peripheral actions to accompany or replace dynamic elements in certain situations. For example, if a calendar application includes a dynamic element of a graphical representation of a bell to indicate that an alarm has been set (e.g., to indicate the start of a meeting), the user may define a color change for the bell within various different time periods prior to the alarm being triggered. In this regard, for example, the bell may normally be yellow, but may turn red within one hour or another predefined time period before the alarm sounds. Alternatively, a beep, vibration or other indication may accompany the bell representation at a predefined interval prior to the alarm sounding. Thus, for example, a short beep may be heard, or a short vibration may be felt at predetermined intervals prior to the alarm sounding and the beep or vibration may be specified to accompany the dynamic element before hand. Another example may be a map related icon in which the current position of the user (or some other specified entity) is updated as the dynamic element on the icon. As yet another example, an icon for a gallery that is made available for others to view may be updated to show a currently viewed or rendered content item (e.g., a thumbnail view or title, etc.). Alternatively, an identity of a contact that is viewing posted content may be indicated as a dynamic element. Other characteristics that may change may include the color, size, shape, graphic associated with the dynamic element, display effects (e.g., flashing, animation, etc.) and/or the like. Augmentations may be accomplished by adding any desirable additional and perceivable mechanism such as audible, visual, mechanically perceptible stimuli. In an exemplary embodiment, the user may define the characteristics and/or peripheral actions to be associated with a particular dynamic element.

Furthermore, in some embodiments, the dynamic element may be based on a parameter associated with an application other than the application associated with the icon. For example, if a particular application is configured to enable communication with another application, a value, property or characteristic of either application may be utilized in part for forming the basis for a dynamic element associated with an adaptive icon of the other application. Additionally, in an exemplary embodiment, the user may be enabled to define what the adaptive icon and/or dynamic element shows. In this regard, for example, a separate application or a menu option may be provided to enable the user to manage relationships between applications with respect to adaptive icons associated therewith and/or define parameters to form the basis of an adaptive icon and corresponding dynamic element for any particular application.

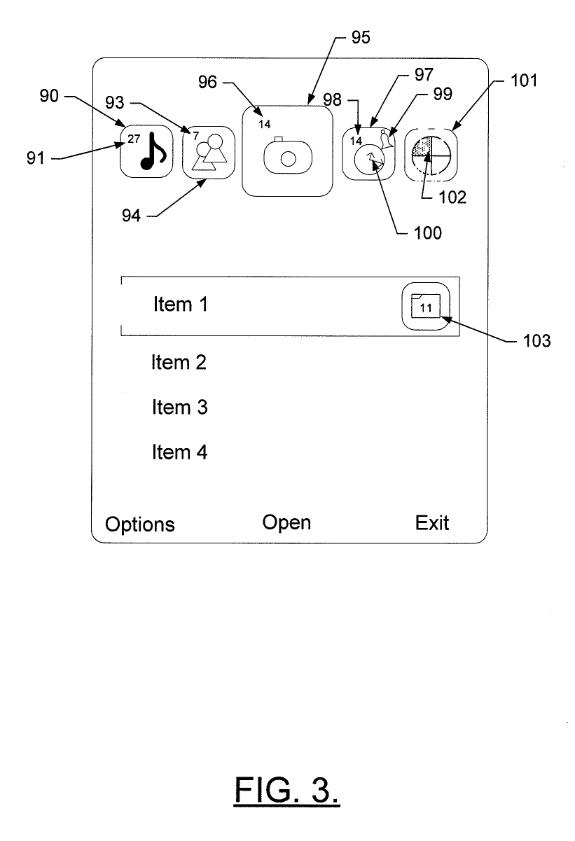

FIG. 3 illustrates an exemplary UI display including adaptive icons in accordance with an exemplary embodiment of the present invention. As shown in FIG. 3, a plurality of adaptive icons (e.g., elements 90, 94, 95, 97 and 101) and a plurality of dynamic elements (e.g., elements 91, 93, 96, 98, 99, 100, 102 and 103). In this regard, for example, a music icon 90 may be presented along with a corresponding dynamic element 91 indicating a number of music playlists, files or folders that may be accessible by selection of the music icon 90. Similarly, a contacts icon 94 may be presented as representative of a contact list that may be accessible by selection of the contacts icon 94. A dynamic element 93 may indicate, for example, a number of contacts in the list or a number of newly received messages from the contacts in the list. An images icon 95 may be presented as representative of various image folders or an image rendering application that may be accessed by selection of the images icon 95. A dynamic element 96 may indicate, for example, a number of files or folders that may be accessed by selection of the images icon 95. A calendar icon 97 may correspond to a calendar application. Dynamic elements such as watch hands 100, which may indicate the current time, and a date indicator 98, which may display the current date, may also be included in the calendar icon 97. A bell icon 99 may be another dynamic element that may indicate that an alarm is currently set as described in greater detail above. A pie chart icon 101 may represent which of various different profiles are currently selected. Thus, for example, while the pie chart icon 101 of this example includes a highlighted pie segment 102 as a dynamic element, any other one of the pie segments could alternatively be highlighted, shaded or otherwise differentiated to indicate that a corresponding different profile is selected.

In an exemplary embodiment, items within an opened or highlighted one of the adaptive icons may also be presented. However, in an exemplary embodiment in which an active idle display is presented, the items themselves may not be presented. Instead only a bar (or bars) including a plurality of adaptive icons may be presented. The items may include or be associated with adaptive icons themselves. In this regard, as illustrated by folder 103, which includes a dynamic element indicative of a number of photos within the corresponding folder associated with the images icon 95, adaptive icons may be free standing or accessible within other menus, subfolders or applications. However, in any case, adaptive icons give the user a preview of information associated with the content behind the icon that would not normally be accessible without selection of the icon.

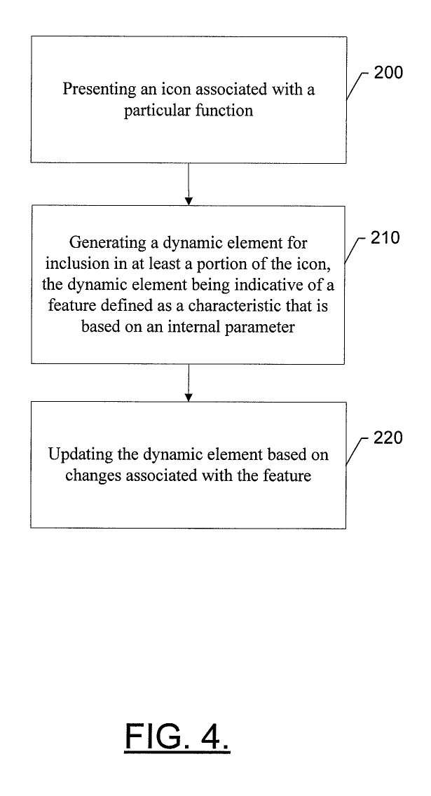

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing an adaptive icon as illustrated, for example, in FIG. 4 may include providing a presentation of an icon associated with a particular function at operation 200 and generating a dynamic element for inclusion in at least a portion of the icon at operation 210. The dynamic element may be indicative of a feature defined as a characteristic that is based on an internal parameter. In this regard, the feature may be associated with execution of the particular function. The method may further include updating the dynamic element based on changes associated with the feature at operation 220. In some embodiments, operation 220 may include presenting a modification to an appearance characteristic of the portion of the icon based on a change to the feature. In this regard, for example, presenting the modification to the appearance characteristic may include altering a graphical element, a textual element, or an additional icon forming at least a portion of the dynamic element or updating the dynamic element based on user preferences defined in a user profile.

In some embodiments the method may include additional operations such as enabling a user to modify display properties associated with the dynamic element or displaying the icon in an active idle mode. In an exemplary embodiment, an augmentation characteristic may be defined. The augmentation characteristic may be configured to change based on a conditional relationship associated with the feature.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing a presentation of an icon associated with a particular function;
generating a dynamic element for inclusion in at least a portion of the icon, the dynamic element being indicative of a feature defined as a characteristic that is based on an internal parameter; and
updating the dynamic element based on changes associated with the feature.

2. A method according to claim 1, wherein updating the dynamic element comprises presenting a modification to an appearance characteristic of the portion of the icon based on a change to the feature.

3. A method according to claim 2, wherein providing a presentation of the modification to the appearance characteristic comprises altering a graphical element, a textual element, or an additional icon forming at least a portion of the dynamic element.

4. A method according to claim 1, further comprising enabling a user to modify display properties associated with the dynamic element.

5. A method according to claim 1, further comprising displaying the icon in an active idle mode.

6. A method according to claim 1, further comprising defining an augmentation characteristic configured to change based on a conditional relationship associated with the feature.

7. A method according to claim 1, wherein updating the dynamic element comprises updating the dynamic element based on user preferences defined in a user profile.

8. A method according to claim 1, wherein the feature is associated with execution of the particular function.

9. A method according to claim 1, further comprising enabling access to the particular function in response to selection of the icon and enabling access to a different function in response to selection of the dynamic element within the icon.

10. A computer program product comprising at least one computer-readable storage medium having computer-readable program code portions stored therein, the computer-readable program code portions comprising:
a first executable portion for providing a presentation of an icon associated with a particular function;
a second executable portion for generating a dynamic element for inclusion in at least a portion of the icon, the dynamic element being indicative of a feature defined as a characteristic that is based on an internal parameter; and
a third executable portion for updating the dynamic element based on changes associated with the feature.

11. A computer program product according to claim 10, wherein the third executable portion includes instructions for presenting a modification to an appearance characteristic of the portion of the icon based on a change to the feature.

12. A computer program product according to claim 11, wherein the third executable portion includes instructions for altering a graphical element, a textual element, or an additional icon forming at least a portion of the dynamic element.

13. A computer program product according to claim 10, further comprising a fourth executable portion for enabling a user to modify display properties associated with the dynamic element.

14. A computer program product according to claim 10, further comprising a fourth executable portion for displaying the icon in an active idle mode.

15. A computer program product according to claim 12, further comprising a fourth executable portion for defining an augmentation characteristic configured to change based on a conditional relationship associated with the feature.

16. A computer program product according to claim 10, wherein the third executable portion includes instructions for updating the dynamic element based on user preferences defined in a user profile.

17. A computer program product according to claim 10, wherein the feature is associated with execution of the particular function.

18. A computer program product according to claim 10, further comprising a fourth executable portion for enabling access to the particular function in response to selection of the icon and enabling access to a different function in response to selection of the dynamic element within the icon.

19. An apparatus comprising a processor configured to:
provide a presentation of an icon associated with a particular function;
generate a dynamic element for inclusion in at least a portion of the icon, the dynamic element being indicative of a feature defined as a characteristic that is based on an internal parameter; and
update the dynamic element based on changes associated with the feature.

20. An apparatus according to claim 19, wherein the processor is further configured to present a modification to an appearance characteristic of the portion of the icon based on a change to the feature.

21. An apparatus according to claim 20, wherein the processor is further configured to alter a graphical element, a textual element, or an additional icon forming at least a portion of the dynamic element.

22. An apparatus according to claim 19, wherein the processor is further configured to enable a user to modify display properties associated with the dynamic element.

23. An apparatus according to claim 19, wherein the processor is further configured to display the icon in an active idle mode.

24. An apparatus according to claim 19, wherein the processor is further configured to define an augmentation characteristic configured to change based on a conditional relationship associated with the feature.

25. An apparatus according to claim 19, wherein the processor is further configured to update the dynamic element based on user preferences defined in a user profile.

26. An apparatus according to claim 19, wherein the feature is associated with execution of the particular function.

27. An apparatus according to claim 19, wherein the processor is further configured to enable access to the particular function in response to selection of the icon and enable access to a different function in response to selection of the dynamic element within the icon.

28. An apparatus comprising:
means for providing a presentation of an icon associated with a particular function;
means for generating a dynamic element for inclusion in at least a portion of the icon, the dynamic element being indicative of a feature defined as a characteristic that is based on an internal parameter; and
means for updating the dynamic element based on changes associated with the feature.
